(19) United States
(12) Patent Application Publication
(10) Pub. No.: US 2026/0163822 A1
(43) Pub. Date: Jun. 11, 2026

(54) SYSTEM AND METHOD OF ROUTE VISUALIZATION IN A HYBRID MULTI-CLOUD NETWORK

(71) Applicant: ALKIRA, INC., San Jose, CA (US)

(72) Inventors: Arjun Sreekantiah, San Jose, CA (US); Shaival Rajan Shah, Durham, NC (US); Srinivas Nukala Veereshwara, San Ramon, CA (US); Joshua Bottelberghe, Vancouver, WA (US)

(21) Appl. No.: 19/414,865

(22) Filed: Dec. 10, 2025

Related U.S. Application Data
(60) Provisional application No. 63/730,401, filed on Dec. 10, 2024.

(51) Int. Cl. H04L 41/22

(52) U.S. Cl. CPC H04L 41/22

(57) ABSTRACT

Disclosed is a method and system of route visualization in a hybrid multi-cloud network. The method comprises receiving and pre-processing the route information to identify unstable or flapping routes and segregate the route information into normal route information and dampened route information, communicating the normal route information and the dampened route information to a cloud storage accessible by a central control plane, receiving the normal route information and the dampened-route information from the cloud storage, processing the normal route information using a cache compute to generate processed route information, processing the dampened-route information without performing the cache compute using a lightweight dampened-route processor to generate processed dampened-route information, storing the processed route information and the processed dampened-route information in a route cache, and providing the processed route information and the processed dampened-route information for visualization of the hybrid multi-cloud network on the customer portal.

### CROSS-REFERENCE TO RELATED APPLICATION

This application claims the benefit of priority to U.S. Provisional No. 63/730,401 entitled “A System and Method of Route Visualization in a Hybrid Multi-Cloud Network” filed on Dec. 10, 2024 which is incorporated herein by reference.

### TECHNOLOGICAL FIELD

The present disclosure generally relates to computer networks and cloud computing systems, and more particularly, relates to systems and methods of route visualization in a hybrid multi-cloud network.

### BACKGROUND

Hybrid multi-cloud network architectures enable enterprises to distribute workloads across multiple cloud service providers and on-premises infrastructure. In such environments, network administrators require real-time visibility into routing information to monitor network health, diagnose connectivity issues, and ensure optimal traffic flow. However, the dynamic nature of cloud networks introduces significant challenges for route visualization. Routes can become unstable or exhibit flapping behavior wherein routes rapidly alternate between available and unavailable states, frequently change advertised prefixes, or display erratic routing metrics. Such instability creates inconsistent network states that complicate visualization and impair network performance.

Traditional route aggregation and visualization systems process all routes uniformly, regardless of stability. When unstable routes trigger frequent updates, the entire route processing pipeline must recompute aggregated network information, which can introduce substantial latency, often up to several minutes, before updated routing information becomes available to network administrators. This delay hinders the ability to quickly identify and resolve network issues, particularly in large-scale deployments where timely visibility is critical for maintaining service quality and operational efficiency.

### SUMMARY

The present disclosure provides a system and a method for efficient route visualization in hybrid multi-cloud networks. More particularly, the present disclosure addresses the challenge of providing real-time network visibility while managing the impact of unstable or flapping routes that would otherwise degrade visualization performance and introduce unacceptable latency.

In hybrid multi-cloud network architectures, customer network entities deployed across multiple cloud service providers generate routing information that must be collected, processed, and presented to network administrators through a customer portal. The present disclosure solves the latency problem by introducing a differentiated processing architecture that segregates route information based on route stability. Routes exhibiting flapping behavior characterized by alternating between available and unavailable states, alternately advertising different destination prefixes, or displaying rapid metric changes are identified and processed separately from stable routes.

The system employs route collectors situated in one or more cloud exchange platforms (CXPs) to receive route information from customer network entities. At the CXPs, the route information undergoes pre-processing to identify unstable or flapping routes. The pre-processed route information is then segregated into normal route information and dampened-route information, with each category stored in separate logical locations within a cloud storage accessible to a central control plane.

The central control plane implements a dual-path processing architecture. For normal route information, the system performs comprehensive cache computation that aggregates route information with customer network and policy information, and route status information to generate processed route information. This cache computation validates routes, collects connector information, processes network address translation (NAT) routes and segment share routes, removes duplicates, and marks overlapping routes. The processed route information provides detailed context necessary for comprehensive network visualization.

In contrast, dampened-route information is processed through a lightweight dampened-route processor that processes without performing the resource-intensive cache computation. By bypassing cache computation for unstable routes, the system significantly reduces processing overhead and prevents flapping routes from triggering repeated cache recomputation cycles that would otherwise introduce substantial latency. The lightweight processor maintains dampened-route information in an internal data structure that can be rapidly accessed when visualization requests are received.

Both the processed route information and the processed dampened-route information are stored in a route cache and made available to a customer portal through an application programming interface (API). When the customer portal requests route visualization, the system retrieves and merges both categories of route information, marks routes identified as dampened, and returns filtered route information for display. The customer portal presents the routes as user-interactive visual elements, enabling network administrators to monitor network topology, identify connectivity issues, and distinguish between stable and unstable routes.

The present disclosure optionally classifies routes into healthy routes, overlapping routes, and churning routes based on the processed route information and processed dampened-route information. Overlapping routes wherein multiple connectors advertise the same network prefix are detected and invalidated to prevent asymmetric routing. Churning routes experiencing flapping behavior are marked and displayed separately, enabling administrators to prioritize remediation efforts.

The differentiated processing architecture enables the system to provide near real-time route visualization even in the presence of unstable routes. By processing dampened routes through a lightweight path that avoids triggering cache recomputation, the system maintains low latency for visualization updates while still providing comprehensive visibility into all routes, including those experiencing stability issues.

In an embodiment, the present disclosure discloses a method of visualizing routes in a hybrid multi-cloud network. The method may comprise receiving, at route collectors of one or more cloud exchange platforms (CXPs), route information generated by customer network entities deployed across multiple cloud regions. The method may further comprise pre-processing, at the CXPs, the route information to identify unstable or flapping routes and segregate the route information into normal route information and dampened-route information. The method may further comprise communicating the normal route information and the dampened-route information to a cloud storage accessible by a central control plane. The method may further comprise receiving, at the central control plane, the normal route information and the dampened-route information from the cloud storage. The method may further comprise processing the normal route information using a cache compute that aggregates the normal route information with customer network and policy information, and route status information to generate processed route information. The method may further comprise processing, the dampened-route information without performing the cache compute, using a lightweight dampened-route processor to generate processed dampened-route information, thereby reducing route-visualization latency relative to normal-route processing. The method may further comprise storing the processed route information and the processed dampened-route information in a route cache. The method may further comprise providing, in response to an API request from a customer portal, the processed route information and the processed dampened-route information for visualization of the hybrid multi-cloud network on the customer portal.

In accordance with an additional method embodiment, identifying unstable routes may comprise detecting routes that alternate between available and unavailable states, alternately advertise different destination prefixes, or exhibit changes in routing metrics exceeding a threshold.

In accordance with an additional method embodiment, the cache compute may exclude internal infrastructure routes and routes having a down BGP peer status.

In accordance with an additional method embodiment, processing the normal route information may comprise determining, for each route, at least one of: connector name, network prefix, segment association, source CXP, NAT status, segment-share status, overlapping-route markers, connection health, or connector type.

In accordance with an additional method embodiment, processing the dampened-route information may comprise maintaining an internal data structure keyed to dampened routes and providing dampened-route information to the customer portal without triggering cache computation.

In accordance with an additional method embodiment, the method may further comprise classifying routes into healthy routes, overlapping routes, and churning routes based on the processed route information and the processed dampened-route information.

In accordance with an additional method embodiment, the normal route information and the dampened-route information may be stored in separate directories in the cloud storage, and the dampened-route processor may listen to the separate directory containing dampened-route information without accessing the directory containing normal route information.

In another aspect, the present disclosure also provides a system for visualizing routes in a hybrid multi-cloud network. The system may comprise one or more cloud exchange platforms (CXPs) including route collectors configured to receive route information from customer network entities and pre-process the route information to segregate normal route information from dampened-route information corresponding to unstable or flapping routes. The system may further comprise a cloud storage configured to store the normal route information and the dampened-route information. The system may further comprise a central control plane comprising a cache compute configured to process the normal route information to generate processed route information, a dampened-route processor configured to process the dampened-route information without performing cache compute operations, a route cache configured to store the processed route information and the processed dampened-route information, and an API handler configured to provide the processed route information and the processed dampened-route information to a customer portal in response to API requests. The system may further comprise a customer portal configured to display visualization of the hybrid multi-cloud network based on the processed route information and the processed dampened-route information.

In accordance with an additional system embodiment, the cloud storage may store the normal route information and the dampened-route information in separate directories.

In accordance with an additional system embodiment, the API handler may include an API gateway configured to authenticate customer-portal requests.

In accordance with an additional system embodiment, the route cache may comprise a distributed key-value store.

In accordance with an additional system embodiment, the customer portal may provide separate user-interface elements for visualizing normal routes, overlapping routes, and churning routes.

In another aspect, the present disclosure also provides a non-transitory computer-readable medium storing instructions that, when executed by processors of a central control plane in a hybrid multi-cloud network, cause the processors to receive normal route information and dampened-route information from a cloud storage, process the normal route information using a cache compute to generate processed route information, process the dampened-route information using a lightweight dampened-route processor without executing the cache compute, store the processed route information and the processed dampened-route information in a route cache, and provide the processed route information and the processed dampened-route information to a customer portal for visualization.

In accordance with an additional non-transitory computer-readable medium embodiment, the instructions may further cause the processors to classify routes into healthy routes, overlapping routes, and churning routes.

In accordance with an additional non-transitory computer-readable medium embodiment, the instructions may further cause the processors to exclude routes having a down BGP peer status from cache computation.

In accordance with an additional non-transitory computer-readable medium embodiment, the instructions may cause the processors to maintain an in-memory data structure associated with dampened routes to respond to customer-portal queries without recomputing the cache.

In accordance with an additional non-transitory computer-readable medium embodiment, the instructions may further cause the processors to merge processed route information and processed dampened-route information into a unified response to an API query.

### BRIEF DESCRIPTION OF THE DRAWINGS

FIG. 1 is a block diagram that illustrates an exemplary network environment for aggregating network information in a hybrid multi-cloud network system, in accordance with an embodiment of the disclosure.

FIG. 2 is a block diagram that illustrates an exemplary CXP node configuration system in a hybrid multi-cloud network system, in accordance with an embodiment of the disclosure.

FIG. 3 is a block diagram that illustrates an exemplary central control plane for aggregating network information in a hybrid multi-cloud network system, in accordance with an embodiment of the disclosure.

FIG. 4 is a block diagram that illustrates an exemplary cache compute for aggregating network information in a hybrid multi-cloud network system, in accordance with an embodiment of the disclosure.

FIG. 5 is a block diagram that illustrates an exemplary central control plane with dampened routes information for aggregating network information in a hybrid multi-cloud network system, in accordance with an embodiment of the disclosure.

FIG. 6A is an exemplary illustration of a customer portal visualizing a global dashboard of a network topology in a hybrid multi-cloud network system, in accordance with an embodiment of the disclosure.

FIG. 6B is an exemplary illustration of a customer portal visualizing network topology in a hybrid multi-cloud network system, in accordance with an embodiment of the disclosure.

FIG. 6C is an exemplary illustration of a customer portal visualizing CXP view of routes of the network topology in a hybrid multi-cloud network system, in accordance with an embodiment of the disclosure.

FIG. 6D is an exemplary illustration of a customer portal visualizing routes of the network topology in a hybrid multi-cloud network system, in accordance with an embodiment of the disclosure.

FIG. 7 is a flowchart that illustrates an example of a method of route visualization to a customer portal in a hybrid multi-cloud network system, in accordance with an embodiment of the disclosure.

### DETAILED DESCRIPTION

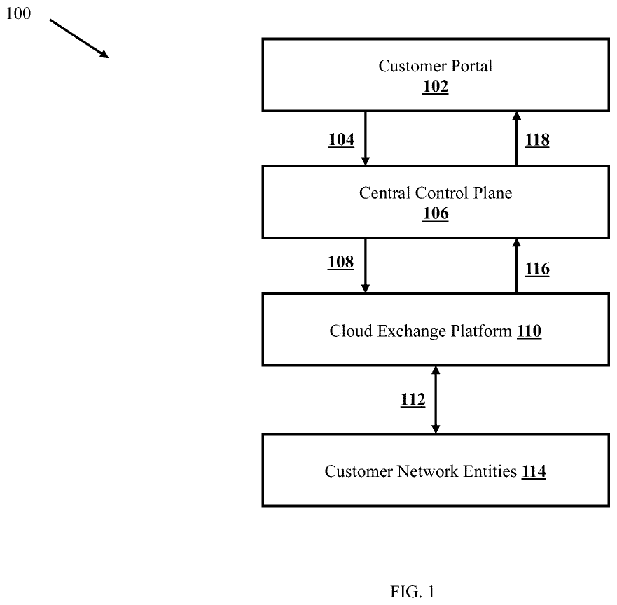

FIG. 1 is a block diagram that illustrates an exemplary network environment for aggregating network information in a hybrid multi-cloud network system, in accordance with an embodiment of the disclosure. With reference to FIG. 1, there is shown a network environment 100. The network environment 100 may include a customer portal 102, a central control plane 106, a cloud exchange platform (CXP) 110, and customer network entities 114. Customers provide network configurations 104 for the customer network entities 114 via the customer portal 102. The central control plane 106 listens to these network configurations and send instructions 108 to the CXP 110 to communicate 112 these network configurations to the customer network entities 114. The network configurations are deployed in the customer network entities 114 and the confirmation is communicated 112 back to the cloud exchange platform 110. After receiving updates regarding the deployment of the network configurations in the customer network entities, the CXP 110 reports 116 these updates to the central control plane 106. The customer portal 102 communicate 118 with the central control plane 106 to receive the deployment confirmation of these network configuration updates and reports these updates as current network connectivity and network status to the customer.

In an example, the Customers provide network configurations 104 for the customer network entities 114 via the customer portal 102. The customer network entities may be a first customer network entities hosted in CXP of US-EAST, a second customer network entities hosted in CXP2 of US-EAST, a third customer network entities hosted in CXP of US-WEST, a fourth customer network entities hosted in Google Cloud Platform of US-CENTRAL and a fifth customer network entities hosted in Azure of US-EAST. All the CXP are communicating with the central control plane 106. The central control plane 106 listens to these network configurations and send instructions 108 to the CXP 110 to communicate 112 these network configurations to the first customer network entities hosted in CXP of US-EAST, the second customer network entities hosted in CXP2 of US-EAST, the third customer network entities hosted in CXP of US-WEST, the fourth customer network entities hosted in Google Cloud Platform of US-CENTRAL and the fifth customer network entities hosted in Azure of US-EAST. The network configurations are deployed in the first customer network entities hosted in CXP of US-EAST, the second customer network entities hosted in CXP2 of US-EAST, the third customer network entities hosted in CXP of US-WEST, the fourth customer network entities hosted in Google Cloud Platform of US-CENTRAL and the fifth customer network entities hosted in Azure of US-EAST and the confirmation is communicated 112 back to the cloud exchange platform 110. After receiving updates regarding the deployment of the network configurations in the customer network entities, the CXP 110 reports 116 these updates to the central control plane 106. The customer portal 102 communicate 118 with the central control plane 106 to receive the deployment confirmation of these network configuration updates and reports these updates as current network connectivity and network status to the customer in the form of visualization.

### Customer Portal

In an embodiment, the customer portal 102 may be a web based user interface where customers can manage their cloud network comprising network entities 114. At the customer portal 102, the route information collected from the network is shown in aggregate to the customer. The customer portal is a single-point access platform that delivers network connectivity and status on a real-time basis through a login experience. Based on specific needs, the customer portal 102 may act as a gateway, providing customers with personalized information regarding their networks deployed across multiple cloud services such as, but not limited to Amazon Web Services (AWS), Microsoft Azure, Google Cloud Platform (GCP), or IBM Cloud. It is to be understood that the customer portal 102 may be rendered on a display device with computing power capable of displaying web based applications. In an embodiment, the customer portal 102 may be available on a computing device of the customer including, a laptop computer, a desktop computer, a handheld computing device and so on.

### Central Control Plane

In an embodiment, the central control plane 106 may be a global control plane including, but not limited to, Kubernetes services managing customer data. Kubernetes is an open-source system for automating deployment, scaling, and management of containerized applications.

The central control plane 106 may also include an API gateway responsible for providing the information to the customer portal 102. The central control plane 106 implements API and associated backend function for services implemented in the hybrid multi-cloud network system 100. The API defines top level abstractions to achieve bidirectional communication between entities involved in the aggregation of network information in the hybrid multi-cloud network system 100.

The central control plane 106 is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. Furthermore, the central control plane 106 may be capable of running across multiple machines and environments: virtual, physical, cloud-based, and on-premises.

### Cloud Exchange Platform

In an embodiment, the CXP 110 may include cloud regions containing nodes acting as routers for the hybrid multi-cloud network system. The nodes may be deployed in all places where customers have cloud resources to ensure the best connectivity and network performance.

The CXP 110 is intended to represent a system that establishes connectivity, instantiates services for corresponding geolocations, aggregates data, implements policies, monitors traffic, and/or provide analytics across disparate cloud service providers and different connectivity architectures such as, but not limited to, AWS, Microsoft Azure, GCP, or IBM Cloud. In a specific implementation, the CXP 110 operates in a manner that—to the customer13 is connectivity agnostic and cloud provider agnostic. The CXP 110 may correspond to aggregated services offered for a given region or set of regions, where the regions may comprise one or more zones corresponding to subsections of such regions. The CXP 110 may service a branch network within a particular region, and multiple CXPs may be stitched together as part of a larger cloud servicing network (e.g., mesh network, hub-and-spoke network, or a network having some other topology) to span multiple regions. In a specific implementation, the CXP 110 provides a portal through which a network administrator or other user associated with a customer may (i) view and select SaaS/IaaS/other services from a range of providers (or provided by the customer itself) within a common dashboard, (ii) manage connectivity (e.g., MLPS, SD-WAN, IPsec, etc.), (iii) monitor traffic, (iv) control traffic in accordance with one or more policies (e.g., security policies), etc. In a specific example, CXPs are deployed in different availability zones for redundancy. All the connections from users, branches and workloads will be multihomed to CXP in each availability zone.

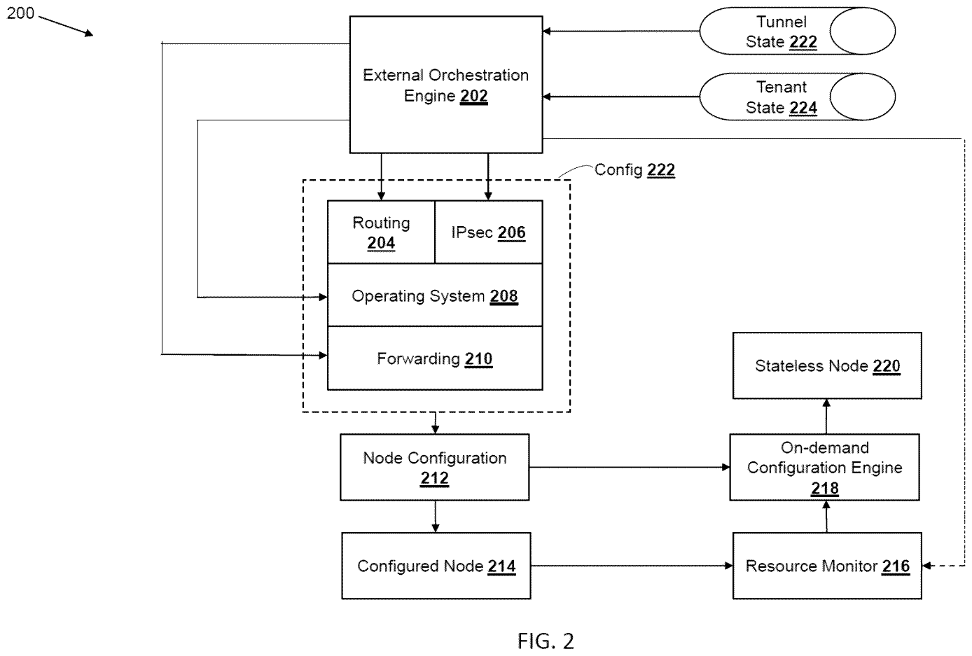

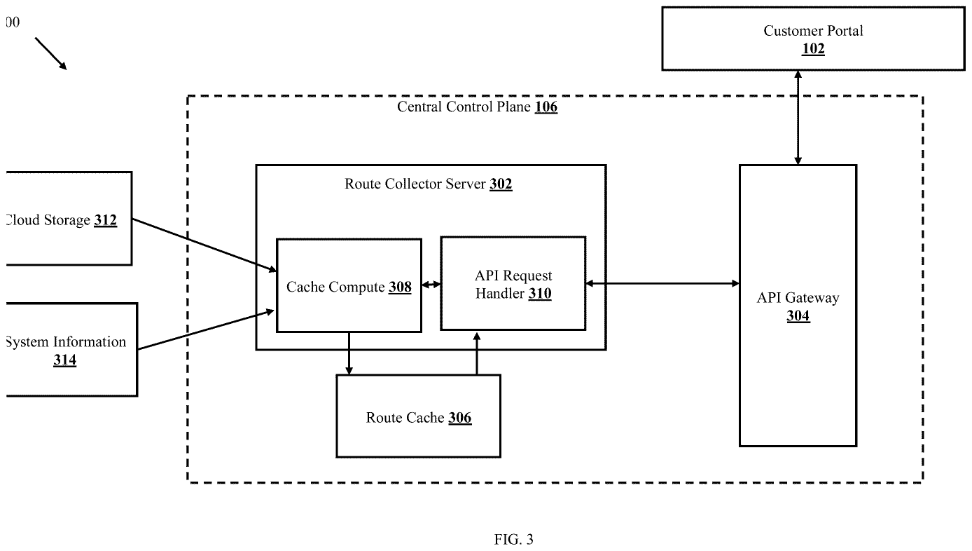

The CXP 110 may include, in addition to other critical components, a routing component and a forwarding component as described in further detail with reference to description of FIG. 2. The forwarding and routing components hold a routing and forwarding table to keep a record of routes or rules that determine where the network traffic from a set of subnets of different segments are directed. The routing and forwarding table is also responsible for storing the next hop of each network and identifying a frame type. Customers may send changes to the network and the CXP 110 will make the required changes and then report the status of the network after the change to the customer via the customer portal 102.

### Customer Network Entities

In an embodiment, the customer network entities 114 may include cloud sites and on-premise resources. The difference between on-premise vs cloud sites is the location. On-premise entities are deployed and hosted locally, whereas cloud sites are deployed on cloud regions. In an example embodiment, all remote locations connect to their closest cloud exchange point, leveraging a variety of on-premises connectors, such as IPSec VPN, SD-WAN, or private cloud cross-connect, for example and not limited to, AWS direct connect or Azure express route. Network configurations related to the customer network entities 114 may refer to internet endpoints and network information a customer has relevant to maintaining the network. In an example, the network configurations may include, but not limited to, internet connectors such as IPsec, SD WAN, AWS Direct Connect, or VMWare, cloud connectors such as, but not limited to, AWS VPC, Azure VNET, Google VPC, and network policies including Network Address Translation (NAT) policy, Network Segment Sharing policy, or Network Rules. Furthermore, the customer network entities 114 may further comprise any networking and/or computing device.

FIG. 2 is a block diagram that illustrates an exemplary CXP node configuration system in a hybrid multi-cloud network system, in accordance with an embodiment of the disclosure. With reference to FIG. 2, there is shown a CXP node configuration system 200. The CXP node configuration system 200 includes an external orchestration engine 202, a routing component 204 coupled to the external orchestration engine 202, an IPsec component 206 coupled to the external orchestration engine 202, an operating system (OS) component 208 coupled to the external orchestration engine 202, and a forwarding component 210 coupled to the external orchestration engine 202. The routing component 204, the IPsec component 206, the OS component 208, and the forwarding component 210 can be collectively referred to as a configuration data structure 222.

The CXP node configuration system 200 further includes a node configuration datastore 212 coupled to the configuration data structure 222, which represents a communication medium from the external orchestration engine 202 over which the configuration data structure is provided for storage in the node configuration datastore 212, a configured node 214 coupled to the node configuration datastore 214, a resource monitor 216 coupled to the configured node 214, an on-demand configuration engine 218 coupled to the resource monitor 216 and the node configuration datastore 212, a stateless node 220 coupled to the on-demand configuration engine 218, a tunnel state datastore 222 coupled to the external orchestration engine 202, and a tenant state datastore 224 coupled to the external orchestration engine 202.

The external orchestration engine 202 is intended to represent an engine that knows tunnel state (represented by the tunnel state datastore 222), which tenant is on which node (represented by the tenant state datastore 224), and how to configure nodes. The term “external” in this context is intended to mean node-external or router-external, as in the external orchestration engine 202 is implemented outside of a router. In a specific implementation, node configuration is performed outside of nodes of a CXP, such as nodes of the CXP 110 of FIG. 1. Advantageously, a node of a CXP can be ripped and replaced due to node configuration being stored outside of the node to be replaced. It may be noted that, with this implementation, it is not necessary for redundant nodes to synch with each other, which is beneficial because redundant nodes have a cost (e.g., synch modules); node-to-node synch communication is at least ameliorated and at best eliminated using the techniques described in this paper.

The routing component 204 is intended to represent a software component implemented on a configured node, such as the configured node 214. Routing forms virtual routing and forwarding (VRF) context for a tenant.

The IPsec component 206 is intended to represent a software component implemented on a configured node, such as the configured node 214. IPsec is a secure network protocol suite that authenticates and encrypts the packets of data to provide secure encrypted communication between two computers over an Internet Protocol network. IPsec includes protocols for establishing mutual authentication between agents at the beginning of a session and negotiation of cryptographic keys to use during the session. In a specific implementation, the IPsec component 206 is compliant with strongSwan, a multiplatform IPsec implementation.

The OS component 208 is intended to represent a software component implemented on a configured node, such as the configured node 214. In a specific implementation, the OS component 208 is compliant with Linux.

The forwarding component 210 is intended to represent a software component implemented on a configured node, such as the configured node 214. Forwarding includes flow management enabling flow-based routing. In a specific implementation, the forwarding component 210 is compliant with vector packet processing (VPP), a software algorithm that is used to quickly process network packets.

The node configuration datastore 212 is intended to represent a datastore of configuration parameters for a node. In a specific implementation, the node configuration datastore is an etcd datastore. etcd is a strongly consistent, distributed key-value store that provides a reliable way to store data that needs to be accessed by a distributed system or cluster of machines. In a specific implementation, the provisioning of nodes is accomplished using an entity relationship diagram (ERD) tool.

The configured node 214 is intended to represent a B-node, an S-node, or a V-node. In a specific implementation, within the configured node 214 are configuration parameters such as represented in the diagram 200 as config data structure 222 (i.e., the routing component 204, the IPsec component 206, the OS component 208, and the forwarding component 210). Although the configured node 214 is coupled to the node configuration datastore 212 and, at least by implication, received configuration parameter values from the node configuration datastore 212, it should be understood that, instead or in addition, the configured node 214 could be pre-configured (i.e., at least partially configured prior to being coupled to the node configuration datastore 212).

The resource monitor 216 is intended to represent an engine that sends a trigger to the on-demand configuration engine 218 responsive to a stimulus from the configured node 214. Instead or in addition, the stimulus could come from some other source, such as the external orchestration engine 202, which is represented in the diagram 200 as a dotted arrow from the external orchestration engine 202 to the resource monitor 216. The stimulus is indicative of a need to spin up additional nodes to handle network resource consumption.

The on-demand configuration engine 218 is intended to represent an engine that provides node configuration parameter values to the stateless node 220 in response to a trigger from the resource monitor. In a specific implementation, the trigger is an indication that additional nodes are needed to handle network resource consumption. If network resource consumption decreases, the stimulus from the configured node 214 to the resource monitor 216 could also trigger the on-demand configuration engine 218 to tear down nodes (not shown).

The stateless node 220 is intended to represent a node that is not initially employed to handle network resource demands (e.g., traffic). Upon obtaining configuration parameter values from the node configuration datastore 212 via the on-demand configuration engine 218, where the configured node 214 is a first configured node, the stateless node 220 becomes a second configured node. In an alternative, the stateless node 220 could initially be handling network resource demands but its configuration is changed by the on-demand configuration engine 218 upon receipt of a trigger at the on-demand configuration engine 218 from the resource monitor 216.

FIG. 3 is a block diagram that illustrates an exemplary central control plane for aggregating network information in a hybrid multi-cloud network system, in accordance with an embodiment of the disclosure. FIG. 3 is explained in conjunction with elements from FIG. 1. With reference to FIG. 3, there is shown a block diagram 300 of the central control plane 106. The central control plane 106 may include a route collector server 302, an API gateway 304, and route cache 306. The API gateway 304 is communicatively coupled to the customer portal 102 and the route collector server 302. The route collector server 302 may include a cache compute 308 and an API request handler 310. The route cache 306 is communicatively coupled to both the cache compute 308 and the API request handler 310. The cache compute 308 listens to the route data or change in the route data stored in a cloud storage 312. The cache compute may also listen to other information related to the hybrid multi-cloud such as system information 314.

### Route Collector Server

In an embodiment, the route collector server 302 may be a golang service running in a Kubernetes cluster in the central control plane 106. In another embodiment, the route collector server 302 may be deployed on a processor or circuitry which may perform operations for collecting network information such as route data from the cloud storage 312, processing the collected network information, and reporting the processed network information of the hybrid multi-cloud network system to the customer portal 102 via the API gateway 304. This is the service which collects all information needed for the route cache, it processes it together and provides it via API so routes can be viewed from the system.

The processor or the circuitry may include suitable logic, circuitry, and interfaces that may be configured to execute program instructions associated with different operations to be executed by the route collector server 302. For example, some of the operations may include reception of route information from the cloud storage 312 and system information 314, creating or computing a cache that contains all important information about each route 308, and reporting the route information to the customer portal 102 via the API gateway 304. The processor or the circuitry may include one or more specialized processing units, which may be implemented as a separate processor. In an embodiment, the one or more specialized processing units may be implemented as an integrated processor or a cluster of processors that perform the functions of the one or more specialized processing units, collectively. The processor or the circuitry may be implemented based on a number of processor technologies known in the art. Examples of implementations of the circuitry 302 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

On API call between the customer 102 and the central control plane 106, the API request handler 310 builds a key to a database, such as the route cache 306, with the information provided in the API query from the customer portal 102, retrieves the route data from the route cache 306, and filters it before returning it to the customer portal 102.

### Api Gateway

In an embodiment, the API gateway 304 is an API management tool that sits between the customer portal 102 and the central control plane 106 interfacing with multiple cloud sites or on-premises resources residing on nodes spread across the hybrid multi-cloud network. API stands for application programming interface, which is a set of definitions and protocols for building and integrating application software.

The API gateway 304 is a component of application delivery (the combination of services that serve an application to users) and acts as a reverse proxy to accept all application programming interface (API) calls, aggregate the various services required to fulfill them, and return the appropriate result. In other words, the API gateway 304 is a piece of software that intercepts API calls from the customer portal 102 and routes them to the appropriate backend service such as reports generated by the route collector server 302.

In order to provide data to the customer website or the customer portal 102, services in the central control plane 106 are exposed through the API gateway 304 which is a common solution to protect services with exposed APIs to unwanted internet traffic and protect the network requests from the customer. The API gateway 304 handles all external API requests to the central control plane 106 to verify credentials and validity of the requests.

### Route Cache

In an embodiment, the route cache 306 includes the stored route information. Route information can be quite large in size so it is broken up into keys and values and stored in an internal database. The internal database may be redis. Alternatively, the internal database may be any other suitable database. Furthermore, in an alternative embodiment, an external database may also be used instead. The route cache 306 allows the data to be stored in a safe place and not slow down the service from excess system memory.

In an example use case in the hybrid multi-cloud network, the route collector server 302 downloads route files or information or data from the cloud storage 312. The cloud storage 312 is capable of receiving information from any geographical region, any cloud region. The cloud storage 312 is capable of storing the information in any file type. The cloud storage 312 may be capable of storing both structured data and unstructured data. An example of the cloud storage 312 may be AWS S3. Alternatively, the cloud storage 312 may be any other suitable cloud storage. Any update in the routing table stored in the nodes hosted across multiple cloud regions is stored as the route files in the cloud storage 312. Cache compute 308 of the route collector server 302 listens to the route files from the cloud storage 312 and computes cache. In another embodiment, the cache compute 308 may also listen to other system information 314 to compute the cache. The other system information 314 may include information about policies in the network as well as mappings of IP addresses and route entities with their real names, for example, connector ID 45516 is used with this data to add the connector name aws-west-2-ipsec to the route. The route cache 306 stores the information computed by the cache compute 308. Details of the processes and functions preformed in the cache compute 308 can be found in more detail with reference to description of FIG. 5.

As and when the customer desires to see the current network connectivity and the status of the network deployed across multiple cloud regions, the customer provides such request through the customer portal 102. The customer portal 102 makes API call to the route collector server 302 via the API gateway 304 to report the information computed by the cache compute 308. Upon receiving the API call, the API request handler 310 builds the key to the route cache 306 with the information provided in the API call, retrieves (from the route cache 306) the information computed by the cache compute 308, and sends the information to the customer portal 102. The customer portal 102 takes the information and displays the routes in a way the customer finds useful.

### Cache Compute

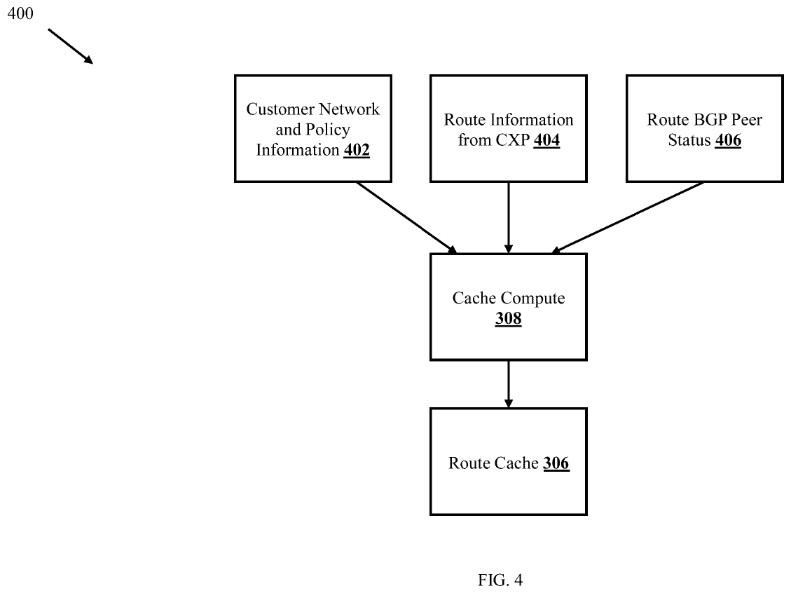

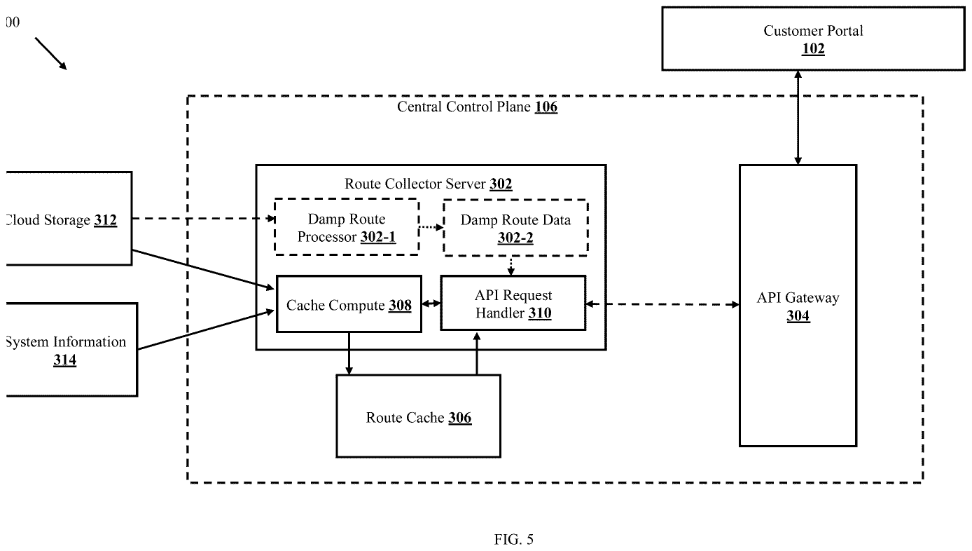

FIG. 4 is a block diagram that illustrates an exemplary cache compute for aggregating network information in a hybrid multi-cloud network system, in accordance with an embodiment of the disclosure. FIG. 4 is explained in conjunction with elements from FIGS. 1 and 3. With reference to FIG. 4, there is shown a block diagram 400 that further describes the process employed for the cache compute 308 as indicated in FIG. 3. In an embodiment, the cache compute 308 may use one or more of customer network and policy information 402, route information from CXP 404, and route BGP peer status 406 to compute cache and store in the route cache 306.

The customer network and policy information 402 refers to stored information about network connectors and network policies. This is fetched by API call from another central control plane service called the Tenant Provisioning Service (TPS). The TPS takes into account the intent of the customer from filling a service provider specific form provided on a website of the service provider. In an embodiment, the service provider may be a provider of the hybrid multi-tenant cloud network system. The customer network and policy information 402 is translated to network configuration and the stored configuration is exposed by an API.

The route information from CXP 404 includes information related to the route tables stored in the cloud storage 312. The cloud storage 312 stores the updated route tables by listening to the updates in the nodes sitting in the CXP 110. In an example, the cloud storage may be AWS S3. In this specific example use case, route information 404 is fetched from AWS S3 by the AWS tooling in golang with the needed AWS credentials.

The route BGP peer status 406 may be referred to as system information, the status of routes as captured from Border Gateway Protocol (BGP) or stored (in a service called Prometheus) to be monitored. The status of the routes may indicate whether the routes are up or down. The status of the routes may also indicate whether the route connection is running or not. This information is collected by the route collector server 302 so that if a route or BGP path is down it is not included in the cache.

The cache compute 308 is the process of processing the customer network and policy information 402, route information from CXP 404, and route BGP peer status 406, and creating a cache that includes all important information about each route.

The important information about each route may comprise at least one of: Connector name—name of connector where the route originates; Prefix—network prefix associated with the route; Segment information—network segment to which the route belongs; Source CXP—CXP the route is sourced from; NAT routes—routes that are NATed are marked with original prefix and name of the nat rule; Seg share routes—routes that are shared between segments are marked accordingly; Overlapping routes—routes that overlap with another route are marked in the cache and displayed accordingly; Connection status—contains health status on the connection; Connector type—type of connector route is from (VPC, IPSEC).

In an embodiment, the important information required for creating the cache may depend on the actions of the customer. It is to be understood that the cache comprising the important information contributes to the ability of the system to understand and validate the network configurations for the customer.

In an embodiment, the cache compute 308 may be processed using the below two steps:
Step 1: Iterate through all route tables for a tenant and add the routes to an aggregate route list func processRoutesForSegment(routes RouteInfo):
a. for each route:
   Check if the route should be added to the cache (internal routes, or routes that go to the alkira nodes, are not shown to the customer as they are part of the routing system
   Collect route connector name and information from stored TPS data and add to route
   Other minor route validations and data collection
b. return the collected validate routes
func computeRouteCache( ):
c. var routes RouteCache//stores routes
d. for each node's route table:
   i. routes:=append(routes, processRoutesForSegment(nodeSegment))
e. // now all routes are collected in one cache
f. . . . proceed to post processing
Step 2: Refine Routes in collected Route Cache
func computeRouteCache( ):
   g. . . .
h. Route aggregation
i. . . .
j. // Process NAT and shared routes
   NAT (network address translation) and segment share (routes shared from one route table to another) routes are handled after all routes are collected because they require information from all routes to be collected first
k. // Sort and remove duplicates
Sort the routes and remove duplicates (fastest to do this together)
Duplicates can occur from nodes in the system that provide redundancy and have the same route path
l. // mark overlap routes
Routes that are overlapping (two routes being advertised over each other) are marked now that information about other routes has been collected. These routes are displayed separately to the customer in the UI because they will want to resolve these routes. Done to avoid asymmetric routing.
m. // store routes in redis
n. marshal routes as a string of JSON and store in redis
o. done

In an embodiment, the output of the cache compute process may be a data structure containing the routes with the refined data. The data structure may be stored in the internal database until it is requested by the API call for visualization on the customer portal 102.

### Overlapping Routes

The routes of the hybrid network topology may become overlapping due to errors in the network configuration. The overlapping refers to the routes advertising same information. In an example, the CXP is deployed in the US-WEST region with Route 1 advertising ipsec as 20.0.0.0/24 and Route 3 advertising ipsec as 10.1.0.0/24 due to error occurred in the network configuration. Similarly, the CXP deployed in the US-EAST with Route 2 advertises ipsec as 10.0.0.0/24. It is to be understood that the same network prefix of two different routes cause route overlapping and is required to be notified to the customer so that the network configuration error can be resolved and the healthy connection with the route may be restored. In this case, the route visualization on the customer portal 102 may display the route address 10.0.0.0/24 as overlapping and generating an alert to the customer.

In an embodiment, the route overlapping may occur due to same prefix advertisement from two different connectors in single CXP with same attributes. For example, the CXP deployed in US-WEST comprises connectors with connector tag 10 and connector tag 20.However, the route address advertisement of both the connectors is 10.10.10.10/32 leading to overlapping of the routes.

In an embodiment, the route overlapping may occur due to same prefix advertisement from two different connectors of two different CXPs with same attributes. For example, CXP deployed in US-EAST with connector having connector tag 20 advertises route address as 10.10.10.10/32 and the CXP deployed in US-WEST with connector having connector tag 10 advertises route address as 10.10.10.10/32 leading to overlapping of the routes.

In an embodiment, the route overlapping may occur due to formation of multiple tunnels to the same connector. In an example, the CXP deployed in US-WEST with connector having connector tag 10 forms two network tunnels with route information advertised as 10.10.10.10/32 and 10.10.10.10/32 from both the tunnels.

In an embodiment, the route overlapping may occur due to same prefix advertisement from two different connectors with different attributes in the same CXP.

### Route Overlap Detection

Route overlap detection is the mechanism to detect if the same route prefix is coming from two different CXPs and no one is preferred over the other. For ECMP (equal cost multi paths) it is fine to receive the same prefix from multiple peers as these peers are to the same branch or data center and having multiple of these increases throughput and enables high availability.

When the same prefix is received from the peer that is not intended to be an ECMP route overlap problem is created. Route overlap leads to asymmetric routing where the traffic comes via one path and returns back via another path.

The customer network entities are connected to the central control plane via connectors. The connector is one resource or entity which is used to connect customer's branches, data-centers, cloud (VPCs, VNETs etc.). Usually there is a direct tunnel between Alkira's node to the customer's end router. Also, for most of the connectors we run BGP over that tunnel.

Ideally each connector is connected to the customer's one branch or data center. Now, many times due to various reasons these different connectors coming into Alkira's network send the same route prefix. Also there is no best among all these routes. All of them are of equal preference. This creates a problem of route asymmetry in the network.

The route asymmetry is a configuration in routing where a packet is received from 1 peer in forward traffic flow and sent back to another peer in reverse traffic flow. As the router that is sending the traffic packet now has multiple routes, it can send the packet on any one of them. It is not guaranteed that it will send to exactly the same peer from which it received the packet first.

In Alkira's context, the overlap is only when the route prefix is received from 2 different connectors. It is assumed that within the single connector all the peers are to the same remote end reaching to the same branch, data center or cloud. Multiple tunnels are only kept for redundancy and more throughput.

For the detection of the overlapping routes, when multiple paths are received for the same route prefix, BGP best path selection checks if there is any path that is best. If it finds the best path, it will only send that path to the forwarding engine. If not, it assumes there are multiple paths possible and sends all the paths to the forwarding engine and those are treated as ECMP.

When a connector peer receives any route in Alkira's CXP, it tags the route with different external communities. One of these tags is a connector tag. Connector tag is the unique value given to each connector. All the routes that are received from that connector peer are tagged with that tag value.

This tag value is accessible by BGP during best path selection. When it reaches to the point where there is no best path and it's trying to treat them as multipath (ECMP), overlap detection kicks in. Before assigning those paths as multipath it checks the connector tag of the paths. If it finds that the connector tag is different for different paths, it treats them as overlaps and invalidates the whole route.

By invalidating the route, that route is not sent to the forwarding engine and traffic won't flow for that route prefix.

### Route Dampening

Routes in customer networks can often be “unstable” or “flapping” due to several networking scenarios that interfere with the ideal working conditions of the router. When there are routes that are unstable/flapping, the network state becomes inconsistent. This is problematic for the performance of the network as well as the route visualization process itself. Frequent route updates cause latency in this visualization process. Route flapping may be a networking issue in which the state of the router fluctuates within a short period of time. In an example, the route flapping may define scenarios where the routers constantly switch between being an available state and an unavailable state, update and withdraw network prefixes (thereby alternatively advertising the two best destination routes), or display drastic changes in any of the routing metrics (such as the BGP table version).

As an example, if a router updates route A to be the best route in its first broadcast, then immediately withdraws it and updates route B to be the best route in its second broadcast, and again updates route A as the best route, the router is flapping. In an example, route flapping may be detected through network packet sniffers, availability monitoring, or manual inspection of router metrics.

Route flapping may severely affect the entire network if left unmanaged. A router that intensively alternates between two destination routes can cause confusion in network traffic routing, thereby causing all connected routers to recalculate the topology frequently. This can easily disrupt the network topology, causing all the upstream connected routers to flap. Unnecessary recalculations and route updates caused by route flapping put a strain on the router's CPU. Intensive CPU usage and constantly changing destination routes can affect router performance and cause network traffic to slow down.

Route Dampening solves the impact of unstable/churning/flapping routes. By identifying the routes we can assign a lower priority to providing updates about these routes so customers can track the ones that are stable. However, the dampened routes are still the part of the network and the only the route information is dampened. Such unstable routes with dampened route information are visualized and notified to the customer by the customer service portal 102.

In an embodiment, a portion of the route dampening process may be executed at the nodes present in the CXP 110 and a portion of the route dampening process may be executed in the central control plane 106. However, the route dampening process is not limited to be executed only in the CXP 110 and the central control plane 106. A person skilled in the art would appreciate that all elements of the hybrid multi-cloud network system could contribute to the execution of the route dampening process.

FIG. 5 is a block diagram that illustrates an exemplary central control plane with dampened routes information for aggregating network information in a hybrid multi-cloud network system, in accordance with an embodiment of the disclosure. FIG. 5 is explained in conjunction with elements from FIG. 3. With reference to FIG. 5, there is shown a block diagram 500 of the central control plane 106. In the flow forward from the route dampening information being stored as the separate file directory in the cloud storage 312, a damp route processor 302-1 of the route collector server 302 may download or listen to that separate file directory related to the dampened route only. With this every change that is pulling from the cloud storage 312, the route collector server is differently computing the cache as damp route data 302-2 and then outputting it out to the customer portal 102 via the API gateway 304. In a way, the routes go into the node 502 and the node 502 exports these routes into files. These files sit in the cloud storage 312. The route collector server 302 downloads these files and takes into consideration the system information 314 to generate the damp route data 302-2.

In an example, the route dampening information stored as the separate file directory in the cloud storage 312 may also be referred to as the damp route files. The separate file directory in the cloud storage 312 may be referred to as the dampened directory. It is to be understood that the directories may be logical locations on cloud storage 312. The damp route files are route files stored in the dampened directory. The damp route files do not go through the cache compute 308 as opposed to regular route files or route files with no route dampening. Thus, saving significant time of the cache compute and reducing latency in visualization. It is not desirable for the cache in the nodes or in the route collector server to be updated with changing/flapping routes because cache update takes a long time and customers cares a lot about how fast is cache updating.

When the route collector server 302 in the central control plane 106 downloads the damp route files, it handles differently. The route collector server 302 stores these damp route files routes internally as damp route data 302-2 after getting processed by the damp route processor 302-1. This way, when a customer requests the network information via the customer portal 102, the customer portal 102 sends an API call to the API gateway 304 which enquires the damp route files separately using the API request handler 310. With this, the damp route data 302-2 (including the damp route files) is supplied to the customer portal 102 bypassing the cache compute 308. Thus, by storing the damp route files of the dampened routes in the separate file and treating them differently, it is evident that these files are not going through cache compute 308, thus, not triggering additional cache compute. The damp route files are going through their own flow which is very fast and light weight in terms of computational and processing time and thereby reducing the time of route visualization for the customer. Beneficially, due to such separate handling of normal route information (through cache compute) and the dampened routes information (without cache compute), the system 100 of the present disclosure provides faster visualization of the network on the customer portal 102.

It is to be understood that the route dampening process is different from the cache computation because no information of the routes is being extracted from the routes themselves. Furthermore, no other information associated with the dampened routes is processed. This allows the dampened routes to be processed with little memory and processing power needed compared to the routes in the cache compute.

When the files are downloaded, route-collector-server 302 takes the dampened routes in the dampened directory and maintains an internal data structure with a unique key associated with the dampened routes. When the API call comes to the central control plane 106 for route visualization, the dampened routes directory is accessed.

These cache computes, for example the cache compute 308, inside the route collector server 302 take much longer (about 4 minutes) to compute the required information. If there are additional files triggering cache computes all the time, it can get the visualization slow down. Since these routes are dampened, customers don't really care so much about their most updated state change because those routes are unstable. After identifying these routes, they are prevented from causing extra visualization updates. These routes are then marked to the customer as potentially problematic routes. Removing the extra updates will improve the latency of network information reaching the customer portal while marking routes can lead to discovery of ways the network can be improved.

The route cache is provided to the customer portal 102 through an API and displays route information to the customer where they can find a global display of their network. In an embodiment, routes that are dampened are marked and shown under a separate tab.

In an embodiment, the marking of the dampened routes may be performed using the below steps:
a. def processDampenedFile(file DampFile):
   i. for each route in file:
1. if route dampened:
A. Markdampenedroute(route)
b. def handleAPI(req request):
   i. routes:=getRoutesFromRedis(req. tenantID)
ii. dampRoutes:=getRoutesMarkedDampenedFromMem(req. tenantID)
iii. for each route in dampRoutes:
1. if route in routes and route. dampened:
a. Mark route in routes as dampened
c. return routes.

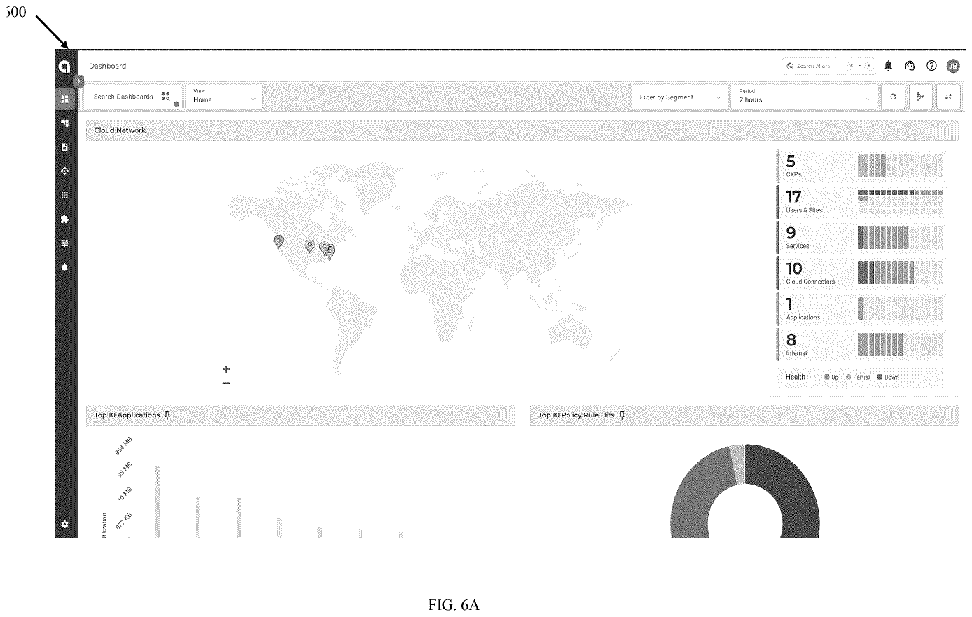

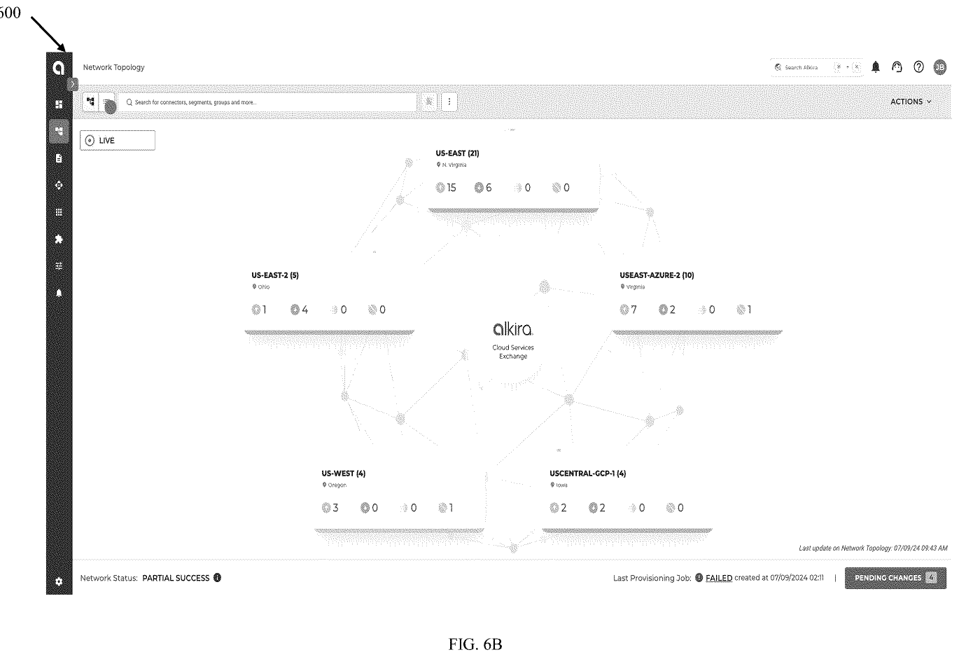

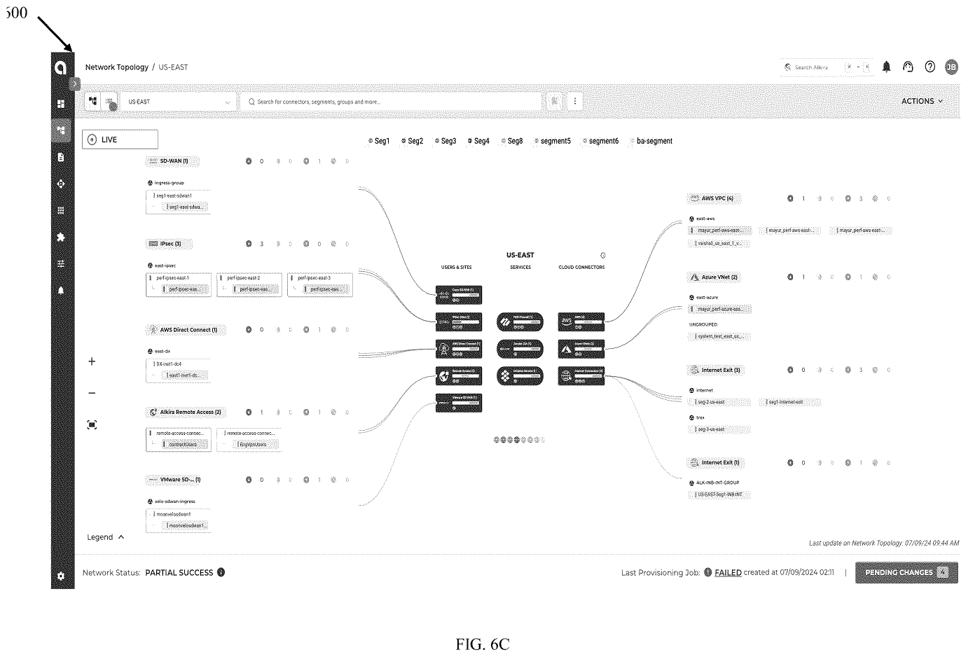

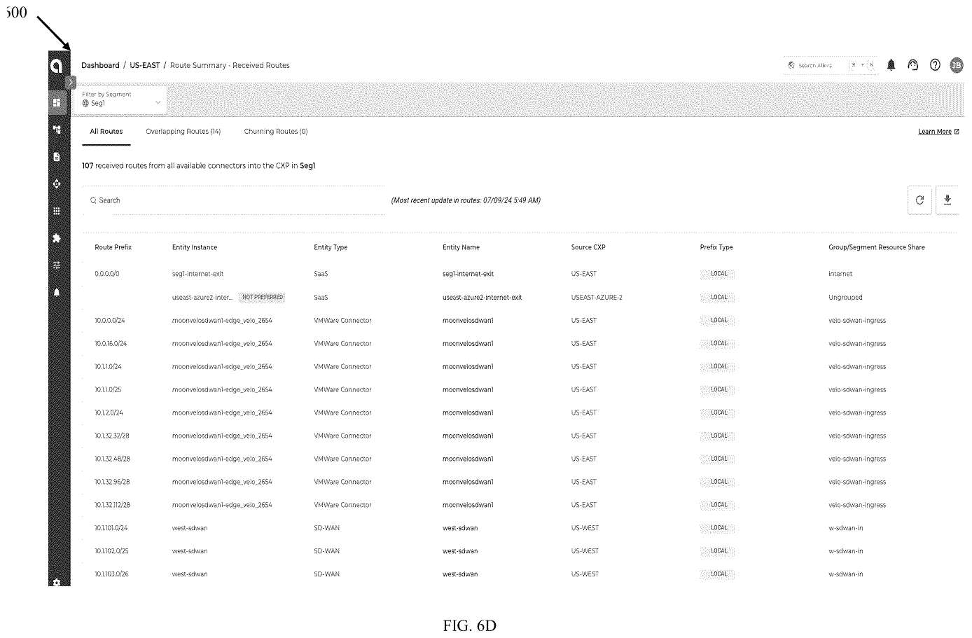

FIG. 6A exemplary illustration of a customer portal visualizing a global dashboard of an

example network topology in a hybrid multi-cloud network system, in accordance with an embodiment of the disclosure. The customer portal 600 (also referred as 102 in the above FIGs.) may comprise a web based interactive user interface. The user interface may be user interactive. In an example, the user interface may comprise elements capable of receiving inputs from the customer (user) and elements capable of displaying information to the customer. The customer may utilize secure login credential to access the customer portal 600 on a computing device capable of displaying information. The customer portal 600 may comprise various user interactive visual elements representing network information and status to the customer. The aggregated network information may be the information pertaining to the CXPs 110 and customer network entities 114. The global dashboard of the example network topology on the customer portal 600 may represent location of CXPs on global geography. The location of the CXPs may be represented as location pins. The global dashboard may also comprise visual elements representing the number of CXPs connected to the central control plane 106, number of users and sites connected to the CXPs, number of connected services, number of cloud connectors, number of applications and so on. Furthermore, the global dashboard may comprise visual elements representing health of the customer network entities and CXPs. The customer network entities or the CXPs may be up, down or partially available.

FIG. 6B is an exemplary illustration of a customer portal visualizing an example network topology in a hybrid multi-cloud network system, in accordance with an embodiment of the disclosure. The exemplary network topology may include a first customer network entities hosted in CXP of US-EAST, a second customer network entities hosted in CXP2 of US-EAST, a third customer network entities hosted in CXP of US-WEST, a fourth customer network entities hosted in Google Cloud Platform of US-CENTRAL and a fifth customer network entities hosted in Azure of US-EAST. All the CXP are communicating with the central control plane 106. The customer portal 600 (also referred as 102 in the above FIGs.) may comprise a web based interactive user interface. The user interface may be user interactive. In an example, the user interface may comprise elements capable of receiving inputs from the customer (user) and elements capable of displaying information to the customer. In a specific embodiment, the information displayed to the customer is the visual representation of route visualization in a hybrid multi-cloud network system. The customer portal 600 visualizes the network topology of the hybrid multi-cloud network system and provide the same to the user as a visual information. The customer may utilize secure login credential to access the customer portal 600 on a computing device capable of displaying information. The customer portal 600 may comprise various user interactive visual elements representing network information and status to the customer. The aggregated network information may be the information pertaining to the CXPs 110 and customer network entities 114.

FIG. 6C is an exemplary illustration of a customer portal visualizing CXP view of routes of an example network topology in a hybrid multi-cloud network system, in accordance with an embodiment of the disclosure. The customer may interact with the customer portal 600 to enter in the CXP view. The CXP may be represented as a visual element in the middle of the customer portal 600. The connectors may be visualized as links to the customer network entities 114. The CXP view represents connectors going in and out of the CXP. The links on the left of the visual representation of the CXP are ingress i.e., the connectors bringing traffic into the CXP. The connectors may be organized by type. Furthermore, the CXP may comprise services such as firewalls and other services. The links on the right of the visual representation of the CXP are cloud connectors connecting to VPCs and other cloud instances. The CXP view displays customer readable information that may be interacted by the customer. In an embodiment, the CXP view may provide information such as route prefix, entity instance, entity type, entity name, source CXP, prefix type, group/segment resource share and so on. In an embodiment, the customer portal 200 may provide a user interactive search tab to search information pertaining to route visualization.

FIG. 6D is an exemplary illustration of a customer portal visualizing routes of the example network topology in a hybrid multi-cloud network system, in accordance with an embodiment of the disclosure. The routes of the network topology in a hybrid multi-cloud system are visualized on the customer portal 600. The routes are displayed as customer readable information and may be interacted by the customer. The customer portal 600 provides segregated tabs to visualize the information of the normal functioning routes, overlapping routes and churning routes. Furthermore, the customer portal 600 provides aggregated route visualization. In an embodiment, the route visualization may provide information such as route prefix, entity instance, entity type, entity name, source CXP, prefix type, group/segment resource share and so on. In an embodiment, the customer portal 200 may provide a user interactive search tab to search information pertaining to route visualization. The internet connectors that advertise these routes are the connections between separate network entities. The connectors are connected to the CSN nodes where the routes are collected. The route visualization process “stiches” the network view together collecting the route information from the nodes about the network.

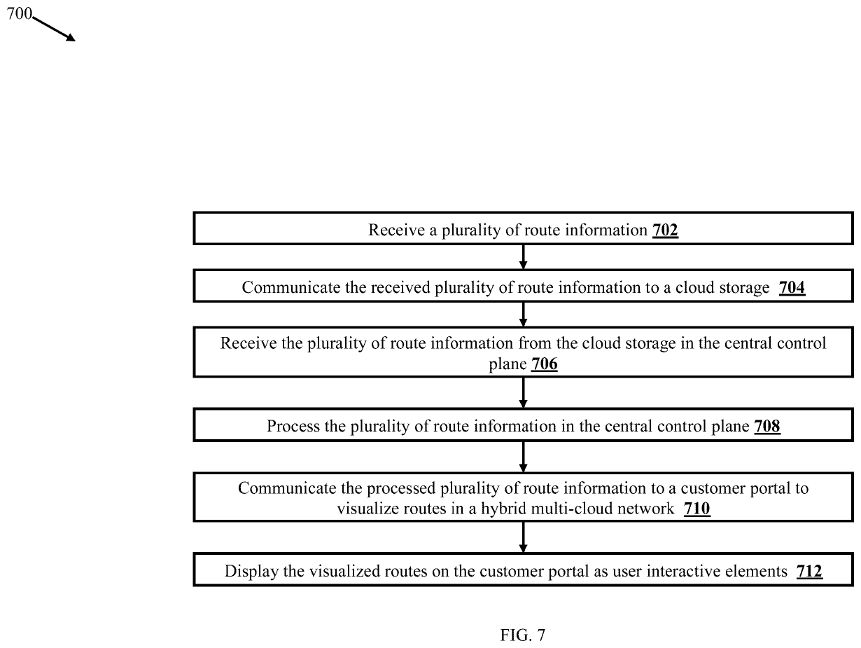

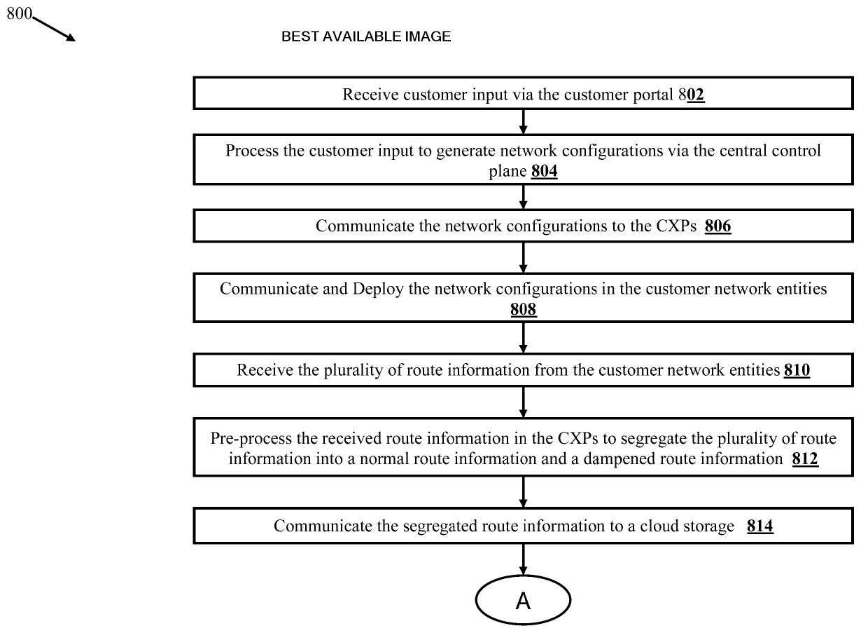

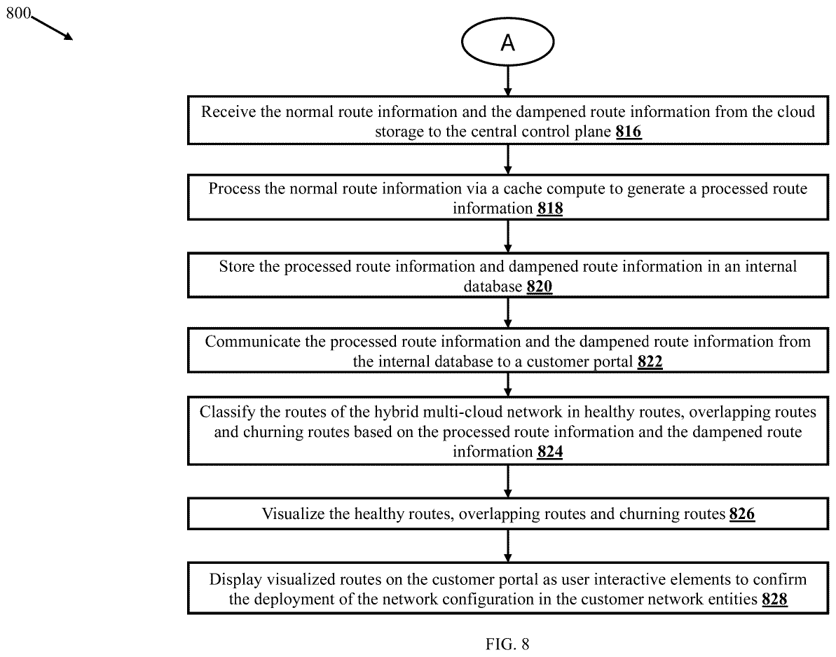

FIG. 7 is a flowchart that illustrates an example of a method of route visualization to a customer portal in a hybrid multi-cloud network system, in accordance with an embodiment of the disclosure. FIG. 7 is explained in conjunction with elements from FIGS. 1-5, 6A and 6B. With reference to FIG. 7, there is shown a flowchart 700. The operations from 702 to 712 may be implemented by any computing system, such as, nodes in the CXP 110, the central control plane 106, the customer portal 102, or a combination of both as shown in FIG. 1. The operations may start at 702 and may proceed to 712.

At 702, the method comprises receiving a plurality of route information of the hybrid multi-cloud network in route collectors situated in cloud exchange platforms. The plurality of route information may be associated with one or network entities hosted as customer network entities in one or more cloud regions or one or more clouds. In an example, the route information may include first route information associated with a first customer network device hosted in AWS GovCloud (US-West), second route information associated with a second customer network device hosted in Azure (East US 3), or third route information associated with a third customer network device hosted in Google Cloud (Asia-East 1).

At 704, the method comprises communicating the received plurality of route information to a cloud storage. The cloud storage may be accessible globally.

At 706, the method comprises receiving the plurality of route information from the cloud storage in the central control plane.

At 708, the method comprises processing the plurality of route information in the central control plane.

At 710, the method comprises communicating the processed plurality of route information to a customer portal to visualize routes in the hybrid multi-cloud network. The processed plurality of route information enables visualization of the route information including first route information associated with the first customer network device hosted in AWS GovCloud (US-West), the second route information associated with the second customer network device hosted in Azure (East US 3), and third route information associated with the third customer network device hosted in Google Cloud (Asia-East 1).

At step 712, the method comprises displaying the visualized routes on the customer portal as user interactive elements.

Although the flowchart 700 is illustrated as discrete operations, such as 702, 704, 706, 708, 710 and 712 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the central control plane 106 and the CXP 110). The computer-executable instructions may cause the machine and/or computer to perform operations as described with reference to steps/functions performed by the central control plane 106 and the CXP 110 in flowchart illustrated by FIG. 7.

Exemplary aspects of the disclosure may include a system (such as the central control plane 106 and the CXP 110 of FIG. 1) that may include circuitry or processor. The system may include one or more hardware processors. The system may also include a memory storing instructions that, when executed by the one or more hardware processors, cause the system to perform operations as described with reference to steps/functions performed by the central control plane 106 and the CXP 110 in flowchart illustrated by FIG. 7.

FIG. 8 is a flowchart that illustrates an example of a method of route visualization to a customer portal in a hybrid multi-cloud network system, in accordance with an embodiment of the disclosure. FIG. 8 is explained in conjunction with elements from FIGS. 1-5, 6A and 6B. With reference to FIG. 8, there is shown a flowchart 800. The operations from 802 to 828 may be implemented by any computing system, such as, nodes in the CXP 110, the central control plane 106, the customer portal 102, or a combination of both as shown in FIG. 1. The operations may start at 802 and may proceed to 828.

At 802, the method comprises receiving customer input via the customer portal.

At 804, the method comprises processing the customer input to generate network configurations via the central control plane.

At 806, the method comprises communicating the network configurations to the CXPs.

At 808, the method comprises communicating and deploying the network configurations in the customer network entities.

At 810, the method comprises receiving the plurality of route information from the customer network entities.

At 812, the method comprises pre-processing the received route information in the CXPs to segregate the plurality of route information into a normal route information and a dampened route information.

At 814, the method comprises communicating the segregated route information to a cloud storage.

At 816, the method comprises receiving the normal route information and the dampened route information from the cloud storage to the central control plane.

At 818, the method comprises processing the normal route information via a cache compute to generate a processed route information.

At 820, the method comprises storing the processed route information and dampened route information in an internal database.

At 822, the method comprises communicating the processed route information and the dampened route information from the internal database to a customer portal.

At 824, the method comprises classifying the routes of the hybrid multi-cloud network in healthy routes, overlapping routes and churning routes based on the processed route information and the dampened route information.

At 826, the method comprises visualizing the healthy routes, overlapping routes and churning routes.

At 828, the method comprises displaying visualized routes on the customer portal as user interactive elements to confirm the deployment of the network configuration in the customer network entities.

Although the flowchart 800 is illustrated as discrete operations, such as 802, 804, 806, 808, 810, 812, 814, 816, 818, 820, 822, 824 and 828 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the central control plane 106 and the CXP 110). The computer-executable instructions may cause the machine and/or computer to perform operations as described with reference to steps/functions performed by the central control plane 106 and the CXP 110 in flowchart illustrated by FIG. 8.

Exemplary aspects of the disclosure may include a system (such as the central control plane 106 and the CXP 110 of FIG. 1) that may include circuitry or processor. The system may include one or more hardware processors. The system may also include a memory storing instructions that, when executed by the one or more hardware processors, cause the system to perform operations as described with reference to steps/functions performed by the central control plane 106 and the CXP 110 in flowchart illustrated by FIG. 8.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed.

What is claimed is:

1. A method of visualizing routes in a hybrid multi-cloud network, comprising:
receiving, at route collectors of one or more cloud exchange platforms (CXPs), route information generated by customer network entities deployed across multiple cloud regions;
pre-processing, at the CXPs, the route information to identify unstable or flapping routes and segregate the route information into normal route information and dampened route information;
communicating, the normal route information and the dampened route information to a cloud storage accessible by a central control plane;
receiving, at the central control plane, the normal route information and the dampened-route information from the cloud storage;
processing, the normal route information using a cache compute that aggregates the normal route information with customer network and policy information, and route status information to generate processed route information;
processing, the dampened-route information without performing the cache compute using a lightweight dampened-route processor to generate processed dampened-route information, thereby reducing route-visualization latency relative to normal-route processing;
storing, the processed route information and the processed dampened-route information in a route cache; and
providing, in response to an API request from a customer portal, the processed route information and the processed dampened-route information for visualization of the hybrid multi-cloud network on the customer portal.

2. The method of claim 1, wherein identifying unstable routes comprises detecting routes that alternate between available and unavailable states, alternately advertise different destination prefixes, or exhibit changes in routing metrics exceeding a threshold.

3. The method of claim 1, wherein the cache compute excludes internal infrastructure routes and routes having a down BGP peer status.

4. The method of claim 1, wherein processing the normal route information comprises determining, for each route, at least one of: connector name, network prefix, segment association, source CXP, NAT status, segment-share status, overlapping-route markers, connection health, or connector type.

5. The method of claim 1, wherein processing the dampened-route information comprises maintaining an internal data structure keyed to dampened routes and providing dampened-route information to the customer portal without triggering cache computation.

6. The method of claim 1, further comprising classifying routes into healthy routes, overlapping routes, and churning routes based on the processed route information and the processed dampened-route information.

7. The method of claim 1, wherein the cache compute aggregates route information from multiple route tables associated with different nodes of the CXPs.

8. The method of claim 1, wherein the dampened-route processor processes the dampened-route information without extracting information from the routes themselves and without processing other information associated with the dampened routes.

9. The method of claim 1, wherein the customer portal displays the routes in an interactive topology view showing locations of CXPs, connectors, and route status.

10. The method of claim 1, further comprising receiving customer configuration input at the customer portal and deploying corresponding network configurations through the CXPs prior to receiving the route information.

11. A system for visualizing routes in a hybrid multi-cloud network, comprising:
one or more cloud exchange platforms (CXPs) including route collectors configured to receive route information from customer network entities and pre-process the route information to segregate normal route information from dampened-route information corresponding to unstable or flapping routes;
a cloud storage configured to store the normal route information and the dampened-route information;
a central control plane comprising:
a cache compute configured to process the normal route information to generate processed route information;
a dampened-route processor configured to process the dampened-route information without performing cache compute operations;
a route cache configured to store the processed route information and the processed dampened-route information; and
an API handler configured to provide the processed route information and the processed dampened-route information to a customer portal in response to API requests; and
a customer portal configured to display visualization of the hybrid multi-cloud network based on the processed route information and the processed dampened-route information.

12. The system of claim 11, wherein the cloud storage stores the normal route information and the dampened-route information in separate logical locations.

13. The system of claim 11, wherein the API handler includes an API gateway configured to authenticate customer-portal requests.

14. The system of claim 11, wherein the route cache comprises a distributed key-value store.

15. The system of claim 11, wherein the customer portal provides separate user-interface elements for visualizing normal routes, overlapping routes, and churning routes.

16. A non-transitory computer-readable medium storing instructions that, when executed by processors of a central control plane in a hybrid multi-cloud network, cause the processors to:
receive normal route information and dampened-route information from a cloud storage;
process the normal route information using a cache compute to generate processed route information;
process the dampened-route information using a lightweight dampened-route processor without executing the cache compute;
store the processed route information and the processed dampened-route information in a route cache; and
provide the processed route information and the processed dampened-route information to a customer portal for visualization.

17. The non-transitory computer-readable medium of claim 16, wherein the instructions further cause the processors to classify routes into healthy routes, overlapping routes, and churning routes.

18. The non-transitory computer-readable medium of claim 16, wherein the instructions further cause the processors to exclude routes having a down BGP peer status from cache computation.

19. The non-transitory computer-readable medium of claim 16, wherein the instructions cause the processors to maintain an in-memory data structure associated with dampened routes to respond to customer-portal queries without recomputing the cache.

20. The non-transitory computer-readable medium of claim 16, wherein the instructions further cause the processors to merge processed route information and processed dampened-route information into a unified response to an API query.
